(19) United States
(12) Patent Application Publication
(10) Pub. No.: US 2016/0071107 A1
(43) Pub. Date: Mar. 10, 2016

(54) METHOD OF PROCESSING A TRANSACTION REQUEST

(71) Applicant: TOUCH NETWORKS AUSTRALIA PTY LTD, Victoria (AU)

(72) Inventor: Jason Andrew Van, Melbourne (AU)

(21) Appl. No.: 14/786,149

(22) PCT Filed: May 9, 2014
(86) PCT No.: PCT/AU2014/000507

§ 371 Date: Oct. 21, 2015

(30) Foreign Application Priority Data
May 14, 2013 (AU) 2013901703

(51) Int. Cl. G06Q 20/40; H04L 29/08

(52) U.S. Cl. CPC G06Q 20/4016; H04L 67/10; G06Q 20/4014

(57) ABSTRACT

A processing system comprises a transaction handler arranged to receive a transaction request from a device over a communications network, an identification obtainer arranged to obtain first identification data of the device from which the transaction request is received and store said first identification data, a verification message sender arranged to send a verification message from the processing system to a nominated user e-mail address, the verification message including a hyperlink specific to the transaction request for verifying the transaction request, and a verification handler arranged to receive an attempt from a device to verify the transaction request based on the hyperlink, the identification obtainer arranged to obtain second identification data from the device attempting to verify the transaction request. The processing system arranged to approve the transaction request upon determining that the second identification data is consistent with the first identification data, and reject the transaction request upon determining that the second identification data is inconsistent with the first identification data.

### FIELD

The invention relates to a method of processing a transaction request and a transaction processing system.

### BACKGROUND

By providing the facility for consumers to purchase goods and services on-line, merchants expose themselves to the potential for fraudulent transactions through these channels.

Accordingly, there is a need for techniques that mitigate against the risk of fraud.

### SUMMARY

In a first aspect, the invention provides a method of processing a transaction request in a processing system, the method comprising:
receiving a transaction request from a device at a processing system over a communications network;
obtaining first identification data of the device from which the transaction request is received and storing said first identification data in the processing system;
sending a verification message from the processing system to a nominated user e-mail address, the verification message including a hyperlink specific to the transaction request for verifying the transaction request;
receiving an attempt from a device to verify the transaction request with the processing system based on the hyperlink;
obtaining second identification data from the device attempting to verify the transaction request;
approving the transaction request with the processing system upon determining with the processing system that the second identification data is consistent with the first identification data; and
rejecting the transaction request with the processing system upon determining with the processing system that the second identification data is inconsistent with the first identification data.

In an embodiment, the first and second identification data each comprise a plurality of data elements and determining whether the second identification data is consistent with the first identification data comprises determining how closely the second identification data matches the first identification data based on a comparison of corresponding data elements of the first and second identification data.

In an embodiment, the method comprises generating a score indicative of how closely the first identification data matches the second identification data and determining from the generated score whether to approve or reject the transaction request.

In an embodiment, the method comprises comparing the generated score to a threshold to determine whether to approve or reject the transaction request.

In an embodiment, the method comprises determining an initial score based on the first identification data and sending the verification message based on the initial score.

In an embodiment, the method comprises adjusting the generated score based on prior device data corresponding to the first identification data.

In an embodiment, the method comprises determining an initial score based on the first identification data and adjusting the score based on a comparison of the second identification data to the first identification data to form an adjusted score, and determining from the adjusted score whether to approve or reject the transaction request.

In an embodiment, the method comprises comparing the adjusted score to a threshold to determine whether to approve or reject the transaction request.

In a second aspect, the invention provides a processing system, the processing system arranged to:
receive a transaction request from a device over a communications network;
obtain first identification data of the device from which the transaction request is received and store said first identification data;
send a verification message from the processing system to a nominated user e-mail address, the verification message including a hyperlink specific to the transaction request for verifying the transaction request;
receive an attempt from a device to verify the transaction request based on the hyperlink;
obtain second identification data from the device attempting to verify the transaction request;
approve the transaction request upon determining that the second identification data is consistent with the first identification data; and
reject the transaction request upon determining that the second identification data is inconsistent with the first identification data.

In a third aspect, the invention provides a processing system comprising:
a transaction handler arranged to receive a transaction request from a device over a communications network;
an identification obtainer arranged to obtain first identification data of the device from which the transaction request is received and store said first identification data;
a verification message sender arranged to send a verification message from the processing system to a nominated user e-mail address, the verification message including a hyperlink specific to the transaction request for verifying the transaction request; and
a verification handler arranged to receive an attempt from a device to verify the transaction request based on the hyperlink, the identification obtainer arranged to obtain second identification data from the device attempting to verify the transaction request,
the processing system arranged to approve the transaction request upon determining that the second identification data is consistent with the first identification data, and reject the transaction request upon determining that the second identification data is inconsistent with the first identification data.

In an embodiment, the processing system comprises an identification comparer arranged to compare the first and second identification data in order to generate comparison data indicative of whether the transaction should be approved or rejected.

In an embodiment, the first and second identification data each comprise a plurality of data elements and the identification comparer generates comparison data based on a comparison of corresponding data elements of the first and second identification data.

In an embodiment, the generated comparison data comprises a score indicative of how closely the first identification data matches the second identification data, and the processing system determines from the generated score whether to approve or reject the transaction request.

In an embodiment, the processing system is arranged to compare the generated score to a threshold to determine whether to approve or reject the transaction request.

In an embodiment, the processing system is arranged to determine an initial score based on the first identification data, and wherein the verification message is based on the initial score.

In an embodiment, the processing system is arranged to adjust the generated score based on prior device data corresponding to the first identification data.

In an embodiment, the processing system is arranged to determine an initial score based on the first identification data and adjust the score based on a comparison of the second identification data to the first identification data to form an adjusted score, and determine from the adjusted score whether to approve or reject the transaction request.

In an embodiment, the processing system is arranged to compare the adjusted score to a threshold to determine whether to approve or reject the transaction request.

The invention also provides computer program code which when executed implements the above method.

The invention also provides a tangible computer readable medium comprising the above computer program code.

### BRIEF DESCRIPTION OF DRAWINGS

Embodiments of the invention will now be described with reference to the accompanying drawings in which:

FIG. 1 is a block diagram of a transaction processing system of an embodiment; and

FIG. 2 is a flow chart of a method of an embodiment.

### DETAILED DESCRIPTION

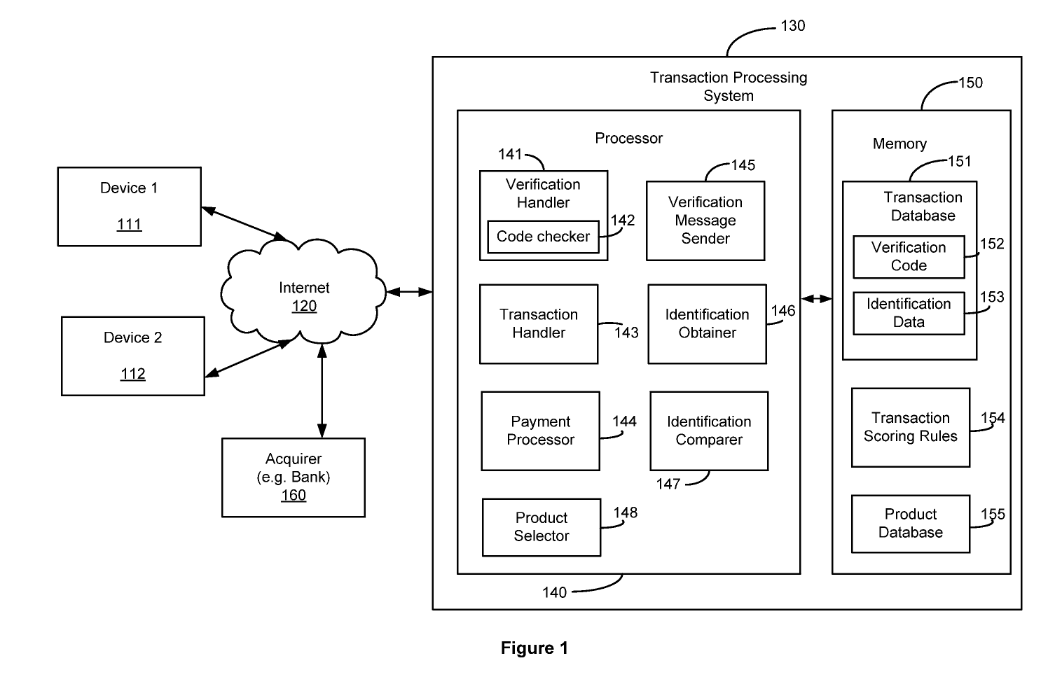

Referring to the drawings, there is shown an embodiment of transaction processing system 130 for implementing a method for processing a transaction request. In FIG. 1, the processor 140 of transaction processing system 130 is shown implementing a number of modules based on program code and data stored in memory 150. Persons skilled in the art will appreciate that one or more of the modules could be implemented in some other way, for example by a dedicated circuit.

The method is implemented by the transaction processing system 130 in response to a customer seeking to purchase an item from the system 130. In this respect, the transaction processing system comprises a product selector 148 implemented by processor 140 which enables a user to browse and select products from the product database 155. In one embodiment, the product selector 148 provides a web interface via which a user can browse products for selection. The product selector 148 may also incorporate known functionality for of e-commerce systems, e.g. a shopping cart application to enable a user to select multiple products to be paid for in a single purchase transaction. In another embodiment, product selection may be implemented by a separate system such that the transaction processing system 130 is employed once a user has chosen products for purchase and is seeking to pay for them. In other embodiments, the transaction may be initiated in another manner, for example by the user selecting a product from an e-mail message sent to the user.

In the system 130, transactions are carried out under the control of the transaction handler 143 which receives the transaction request from a device 111 (for example via the product selector 148) and ensures that all the steps of the method are carried out.

The items in product database 155 may be physical items of some particular value, for example, a mobile handset for $500 or a virtual item such as a recharge voucher for applying credit to a pre-paid mobile phone account. That is, in exchange for payment, the user is provided with a code that they can enter in order to apply credit to a prepaid mobile account and as such, may not be provided with a physical receipt.

During the purchase transaction, for example when the user initiates an attempts to pay, identification obtainer 146 of the system 130 sends a message to the customer's device which is being used to conduct the transaction in order to obtain device identification data from that device 111. The information obtained will differ based on the type of device and the specific implementation. For example, the device may be a desktop or laptop computer running a Windows or Mac operating system (“OS”) such as Windows 8 (a product of Microsoft Corporation) or OS X Mountain Lion (a product of Apple Inc) or a mobile device such as a mobile (cell) phone or tablet computer running a mobile operating system such as Android 4.0 (from Google, Inc) or iOS 6.0 (from Apple Inc) and may be connected to the system 130 by different types of Internet connections and as such, there is potential for varying scopes of data to be captured that will identify the device 111 directly or provide an indication of the location of the device. In one embodiment, the identification data that is obtained may include certain attributes of the device (such as its operating system and version, CPU serial number, Memory serial numbers, hard drive serial number and size, an IP address, a Geolocation. After these are obtained by the identification obtainer 146, they are stored in a transaction database as identification data 153. For example, the identification data may be stored against a user account record identified by a reference such as the user's mobile phone number.

In the embodiment, the transaction handler 143 is arranged to ask the user to enter a valid email address, for example, after collection of the device identification data.

The transaction handler also causes payment processor 144 to communicate with an acquirer system 160 (e.g. a system belonging to a bank) to obtain authorisation of the payment tendered by the user. For example, an authorisation on the customer's credit card is performing allowing the funds for the product to be settled from the customer's credit account. In the event that another form of payment is used (such as PayPal), a similar authorisation is obtained.

Once the purchase transaction is considered successful from a credit worthiness perspective, the customer is advised that they will be sent a verification message in the form of an email to the email address that they have entered. The customer will also be advised that they must respond to the email within a period of time (that can be configured and may be, for example, 12 hours) in order to complete the order and receive their item(s). This e-mail message is sent by the verification messaged sender 145. Depending on the embodiment, the customer may be blocked by the system 130 from engaging in any additional transaction until a response is received to the email (as may be the device 111 and other elements such as the credit card).

The verification message sender 145 is arranged to incorporate a link into the e-mail message that allows the e-mail address to be verified. In some embodiment such a verification link also includes a verification code derived from the user's details. The verification code 152 is stored in the database 151 in association with the identification data for the transaction. As such, the email issued to the user contains a specific secure link to a processing site controlled by verification handler 141 of processing system 130. When the user clicks on this link, the database is updated to indicate that the e-mail address is valid. In some embodiments, the user is also asked to enter their user details again so that a cross-check can be performed on the verification code.

When the customer accesses the specific secure link, the identification obtainer issues a second device identification request to the device used to access the link to obtain second identification data. The device may be the same device (Device 1 111) or another device (Device 2 112). Identification comparer 147 compares the second identification data with the stored first identification data 153 to determine whether it is consistent. In one embodiment, this is performed by allocating a score based on transaction scoring rules 154. The transaction scoring rules 154 control the degree of compliance required. For example, in some embodiments an exact match may be required such that all confirmation requests from another device 112 may be rejected. In other embodiments it may be sufficient that the geolocation or IP address of the first and second devices are consistent. In some embodiments the score is derived based on the comparison of the first and second identification data by the identification comparer. In another embodiment, an initial score is allocated based on the initial information obtained from the device (for example by allocating or deducting point values based on items of data that are present) and the score is adjusted based on the comparison to the second identification data to form an adjusted score.

From the above it will be appreciated that the purchase transaction may be rejected or approved. For example by comparing the score to a defined threshold. If the purchase transaction is rejected, then the funds set aside for authorisation are subjected to a void process, and no credit is deducted from the customer's credit card (or other payment form) account.

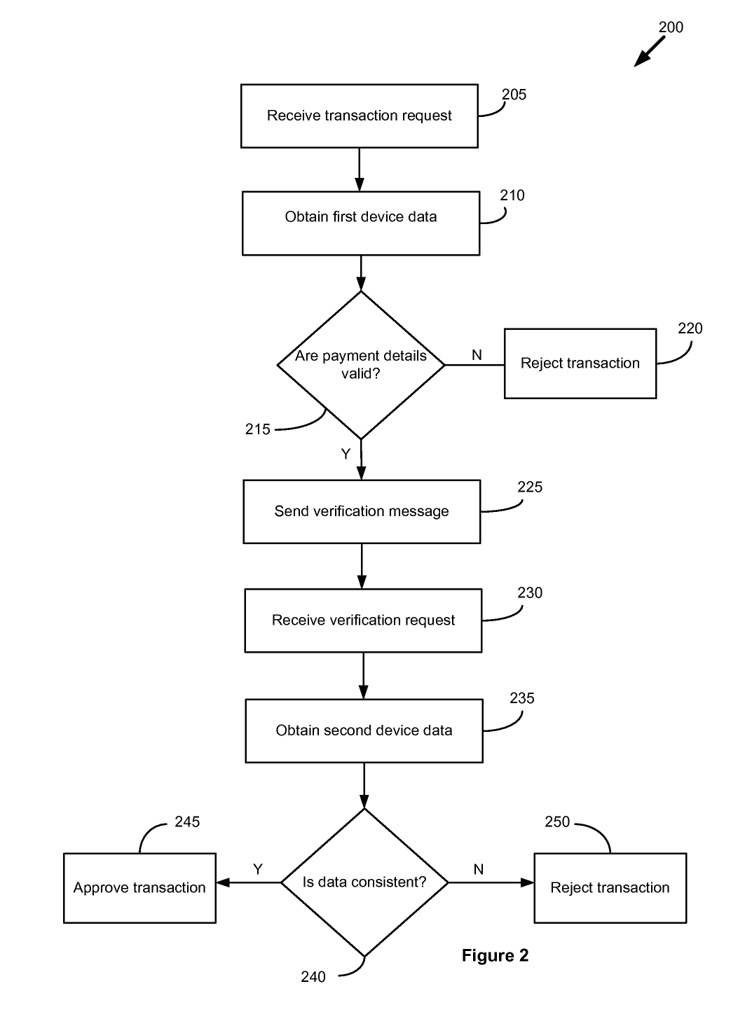

Referring to FIG. 2, there is shown a method 200 of one embodiment. The method involves receiving 205 a transaction request, obtaining 210 first device identification data and determining whether payment details are valid 215. If the payment details are invalid, the transaction is rejected 220. If the payment details are valid, a verification message 225 is sent to an email address nominated by the user. The user clicks on a link within the email message causing the system 130 receives a verification request 230 from the user device used to select the link. The processing system 130 then obtains second device identification data 235. The method then involves determining 240 whether the data is consistent with the first device identification data. If the data is consistent, the transaction is approved 245. If the data is inconsistent, the transaction is rejected 250.

### Example

A customer places a request to purchase a physical product on a web site managed by the transaction processing system. The device “appearing” to be presented by the customer is an Apple iPhone 4S with IOS 6.1 software installed. Also derived from the device by the identification obtainer 146 are other ID markings such as:
name of the device (e.g. the user's iTunes user name)
telecommunication network provider (the entity that provides the phone service to the user)
network carrier (the entity that provides the physical infrastructure used by the telecommunication network provider (which may be the same or different)
serial number of the device
capacity of the device
network carrier's operating system version
WiFi address used for the transaction (if used)
Bluetooth address of the device (if turned on)
IMEI (International Mobile Station Equipment Identity) number
ICCID number (a SIM (subscriber identification module) card serial number
modem firmware version

(The above list is specifically for an Apple iPhone. However, as discussed above, the list would vary based on the device.)

The above information is recorded to the extent that it is complete. Some fields for each device ID list are mandatory and some are not and this differs for device. For example, the WiFi address and Bluetooth address of an iPhone device are not mandatory as, in order to collect them, both services need to be turned on. Where these fields are completed, this adds positively (in the sense of improving) an initial score for the first identification data.

For example, the processing system may initially score an iPhone5 with all of the above fields (and additional attributes) with a score of 0 points as the identification obtainer 146 was able to obtain the total device information possible. (A lower score being treated as more indicative that the device is trustworthy). If the WiFi field was not populated but identification obtainer 146 received an IP address along with the incoming details then the device may be treated as suspicious and granted a score of 25 points.

In one example, the device details are matched internally against existing device details. In one example, the score may be decreased based on the number of transactions previously presented where that particular device was used and the transactions either failed or were considered of a fraudulent nature. That is, a device ID may have been presented previously and be used in multiple successful transactions. Over time, those individual transactions begin to garner their own score weighting to the initial score. A successful transaction using a particular device ID that was performed 9 months ago and has not had a chargeback or refund against it has a negative score against it (say −5), where a successful transaction performed today may only receive −1 points. The reason for the different scores is that, although a transaction today is successful, a bank may apply a chargeback against the transaction anywhere (generally) up to 180 days past the date of the transaction.

A high score at this point may be used to fail a transaction. Otherwise the processing system 130 proceeds to, in effect, test the device ID (“identification”) by requiring an email to be “answered” by a customer after a transaction is otherwise completed, in order that the transaction outcome be fulfilled by supplying the item. In some embodiments, some scores (e.g. a “0” may be exempt from this testing process).

As indicated above, the email has a link that the customer must click on to complete the transaction. The link takes the customer to the confirmation process page hosted by a secure web server. The link contains a unique key specific to the transaction that cannot be replicated.

The customer clicks on the link and a second device ID check is performed. The first device ID is then validated, attribute by attribute, against the second device ID.

In one example, if the 2 device IDs match (attribute for attribute) then the score for the device ID is 0. If the 2 device IDs do not match, but the devices are of the same type (for example both are iPhones), then based on the attributes presented by both devices a score between 0 and 100 will be given, based on the attributes presented and the attribute differences, save for predetermined attributes (such as WiFi and Bluetooth addresses). This score is based on a matrix of attributes available and each attribute value. If the 2 device IDs do not match and the devices are different types of devices (for example one iPhone and one Android phone), then the score may be 100. Alternatively if the devices use the same IP address indicative that the two devices are being used on the same network, a score of 50 may result.

As with the initial score process described above, a history of transactions may be used to adjust the score. In another variant, a time value derived from the time between the email (as per the example above) being issued and the response time by the customer may be factored into the score. The longer the time to respond (for certain transactions) the more of a scoring penalty may be applied.

Persons skilled in the art will appreciate that in accordance with known techniques, functionality at the server side of the network may be distributed over a plurality of different computers, for example for load balancing or security.

Further aspects of the method will be apparent from the above description of the system. It will be appreciated that at least part of the method will be implemented electronically, for example, digitally by a processor executing program code. In this respect, in the above description certain steps are described as being carried out by the system, it will be appreciated that such steps will often require a number of sub-steps to be carried out for the steps to be implemented electronically, for example due to hardware or programming limitations. For example, to carry out a step such as evaluating, determining or selecting, a processor may need to compute several values and compare those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art will appreciate that program code provides a series of instructions executable by a processor.

Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of processing a transaction request in a processing system, the method comprising:
receiving a transaction request from a device at a processing system over a communications network;
obtaining first identification data of the device from which the transaction request is received and storing said first identification data in the processing system;
sending a verification message froth the processing system to a nominated user e-mail address, the verification message including a hyperlink specific to the transaction request for verifying the transaction request;
receiving an attempt from a device which is either the same device as the device from which the transaction request is received or another device to verify the transaction request with the processing system based on the hyperlink;
obtaining second identification data from the device attempting to verify the transaction request;
approving the transaction request with the processing system upon determining with the processing system that the second identification data is consistent with the first identification data; and
rejecting the transaction request with the processing system upon determining with the processing system that the second identification data is inconsistent with the first identification data.

2. A method as claimed in claim 1, wherein the first and second identification data each comprise a plurality of data elements and determining whether the second identification data is consistent with the first identification data comprises determining how closely the second identification data matches the first identification data based on a comparison of corresponding data elements of the first and second identification data.

3. A method as claimed in claim 2, comprising generating a score indicative of how closely the first identification data matches the second identification data and determining from the generated score whether to approve or reject the transaction request.

4. A method as claimed in claim 3, comprising comparing the generated score to a threshold to determine whether to approve or reject the transaction request.

5. A method as claimed in claim 1, comprising determining an initial score based on the first identification data and sending the verification message based on the initial score.

6. A method as claimed in claim 3, further comprising adjusting the generated score based on prior device data corresponding to the first identification data.

7. A method as claimed in claim 1, comprising determining an initial score based on the first identification data and adjusting the score based on a comparison of the second identification data to the first identification data to form an adjusted score, and determining from the adjusted score whether to approve or reject the transaction request.

8. A method as claimed in claim 7, comprising comparing the adjusted score to a threshold to determine whether to approve or reject the transaction request.

9. A processing system, the processing system arranged to:
receive a transaction request from a device over a communications network;
obtain first identification data of the device from which the transaction request is received and store said first identification data;
send a verification message from the processing system to a nominated user e-mail address, the verification message including a hyperlink specific to the transaction request for verifying the transaction request;
receive an attempt from a device which is either the same device as the device from which the transaction request is received or another device to verify the transaction request based on the hyperlink;
obtain second identification data from the device attempting to verify the transaction request;
approve the transaction request upon determining that the second identification data is consistent with the first identification data; and
reject the transaction request upon determining that the second identification data is inconsistent with the first identification data.

10. A processing system comprising:
a transaction handler arranged to receive a transaction request from a device over a communications network;
an identification obtainer arranged to obtain first identification data of the device from which the transaction request is received and store said first identification data;
a verification message sender arranged to send a verification message from the processing system to a nominated user e-mail address, the verification message including a hyperlink specific to the transaction request for verifying the transaction request; and
a verification handler arranged to receive an attempt from a device to verify the transaction request based on the hyperlink, the identification obtainer arranged to obtain second identification data from the device attempting to verify the transaction request,
the processing system arranged to approve the transaction request upon determining that the second identification data is consistent with the first identification data, and reject the transaction request upon determining that the second identification data is inconsistent with the first identification data.

11. A processing system as claimed in claim 10, comprising an identification comparer arranged to compare the first and second identification data in order to generate comparison data indicative of whether the transaction should be approved or rejected.

12. A processing system as claimed in claim 10, wherein the first and second identification data each comprise a plurality of data elements and the identification comparer generates comparison data based on a comparison of corresponding data elements of the first and second identification data.

13. A processing system as claimed in claim 11, wherein the generated comparison data comprises a score indicative of how closely the first identification data matches the second identification data, and the processing system determines from the generated score whether to approve or reject the transaction request.

14. A processing system as claimed in claim 13, arranged to compare the generated score to a threshold to determine whether to approve or reject the transaction request.

15. A processing system as claimed in claim 10, arranged to determine an initial score based on the first identification data, and wherein the verification message is based on the initial score.

16. A processing system as claimed in claim 13, arranged to adjust the generated score based on prior device data corresponding to the first identification data.

17. A processing system as claimed in claim 11, arranged to determine an initial score based on the first identification data and adjust the score based on a comparison of the second identification data to the first identification data to form an adjusted score, and determine from the adjusted score whether to approve or reject the transaction request.

18. A processing system as claimed in claim 17, arranged to compare the adjusted score to a threshold to determine whether to approve or reject the transaction request.

19. (canceled)

20. A tangible computer readable medium comprising the computer program code which when executed by a processor implements the method of claim 1.
